(19) United States
(12) Patent Application Publication
(10) Pub. No.: US 2020/0148350 A1
(43) Pub. Date: May 14, 2020

(54) UNMANNED AIRCRAFT

(71) Applicant: SZ DJI TECHNOLOGY CO., LTD., Shenzhen (CN)

(72) Inventors: Guisheng NONG, Shenzhen (CN); Lei ZHANG, Shenzhen (CN); Yin TANG, Shenzhen (CN)

(21) Appl. No.: 16/596,343

(22) Filed: Oct. 8, 2019

Related U.S. Application Data
(63) Continuation of application No. PCT/CN2017/081944, filed on Apr. 26, 2017.

(51) Int. Cl. B64C 39/02; B64D 47/08; H01M 2/10

(52) U.S. Cl. CPC B64C 39/024; B64D 47/08; H01M 2220/20; B64C 2201/042; B64C 2201/127; H01M 2/1083

(57) ABSTRACT

An unmanned aircraft includes an aircraft main body, a motherboard disposed inside the aircraft main body, and a top cover mounted on the aircraft main body and configured to seal the motherboard inside the aircraft main body. The unmanned aircraft also includes a battery, a gimbal assembly module, and an antenna assembly disposed at a lower portion of the aircraft main body. The battery is disposed at a rear lower portion of the aircraft main body, the gimbal assembly module is located at a front lower portion of the aircraft main body, and the antenna assembly is between the battery and the gimbal assembly module.

### CROSS-REFERENCE TO RELATED APPLICATION

This application is a continuation application of International Application No. PCT/CN2017/081944, filed on Apr. 26, 2017, the entire content of which is incorporated herein by reference.

### TECHNICAL FIELD

The present disclosure relates to the technology field of unmanned aerial vehicles and, more particularly, to an unmanned aircraft having an overall compact configuration.

### BACKGROUND

The mounting location of the battery in currently available unmanned aircrafts is often selected at the center location of the aircraft body. The battery may be optionally mounted into the inside of the aircraft body from above or below the aircraft body. In this configuration, the battery is wrapped inside the aircraft body. Gaps between the battery and two sides of the aircraft body are not used. In addition, the thickness of the walls on both sides are increased, which results in an increase in the volume and weight of the unmanned aircraft. Further, the spaces between the battery and the aircraft body at the fore and aft are not convenient for use, and the utilization rate of which is low.

### SUMMARY

In accordance with an aspect of the present disclosure, there is provided an unmanned aircraft including an aircraft main body, a motherboard disposed inside the aircraft main body, and a top cover mounted on the aircraft main body and configured to seal the motherboard inside the aircraft main body. The unmanned aircraft also includes a battery, a gimbal assembly module, and an antenna assembly disposed at a lower portion of the aircraft main body. The battery is disposed at a rear lower portion of the aircraft main body, the gimbal assembly module is located at a front lower portion of the aircraft main body, and the antenna assembly is between the battery and the gimbal assembly module.

The unmanned aircraft of the present disclosure includes a top cover mounted at a top portion of a main body of the aircraft, and a battery and a gimbal assembly module mounted at a lower portion of the main body of the aircraft, such that the overall configuration of the aircraft is compact. The appearance is smooth and aesthetically pleasing. Space utilization rate is also high, and weight of the aircraft is reduced. The disclosed configuration of the aircraft can increase the flight time of the unmanned aircraft.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a side perspective view of an unmanned aircraft, according to an example embodiment.

FIG. 2 is an exploded view of the unmanned aircraft, according to an example embodiment.

FIG. 3 is a front perspective view of the unmanned aircraft, according to another example embodiment.

FIG. 4 is a top perspective view of the unmanned aircraft, according to another example embodiment.

FIG. 5 is a bottom perspective view of the unmanned aircraft, according to another example embodiment.

### DETAILED DESCRIPTION OF THE EMBODIMENTS

Next, the technical solutions of the present disclosure will be described in detail with reference to the accompanying drawings. The described embodiments are only some, but not all of the embodiments of the present disclosure. Based on the described embodiments, a person having ordinary skills in the art can modify or improve the various features of the present disclosure without departing from the principle of the various embodiments disclosed herein and without making creative efforts. Such modification or improvement also fall within the scope of the present disclosure.

The illustrative embodiments will be described in detail, which are shown in the accompanying drawings. When the descriptions refer to the drawings, unless otherwise specified, the same numbers in different drawings refer to the same or similar elements. The implementation methods described in the following illustrative embodiments do not represent all of the implementation methods consistent with the present disclosure. Instead, they are only examples of device and method consistent with some aspects of the present disclosure described in the claims.

The terms used herein are only for the purpose of describing certain embodiments, and are not intended to limit the scope of the present disclosure. The singular forms “a,” “an,” and “the” used in the specification and the claims are intended to include the plural forms as well, unless the context indicates otherwise. The term “and/or” used herein includes any suitable combination of one or more related items listed. The term “and/or” may be interpreted as “at least one of.” For example, A and/or B may be interpreted as at least one of A or B, such as A, B, or A and B. The symbol “/” means “or” between the related items separated by the symbol. The phrase “at least one of A, B, or C” encompasses all combinations of A, B, and C, such as A only, B only, C only, A and B, B and C, A and C, and A, B, and C.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. In some contexts, the terms “disposed,” “provided,” and “located” may be interchangeable. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” “front,” “rear,” and similar expressions used herein are merely intended for describing relative positional relationship.

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, the unmanned aircraft is described with reference to the drawings. When there is no obvious conflict, the various embodiments and various features of the embodiments may be combined.

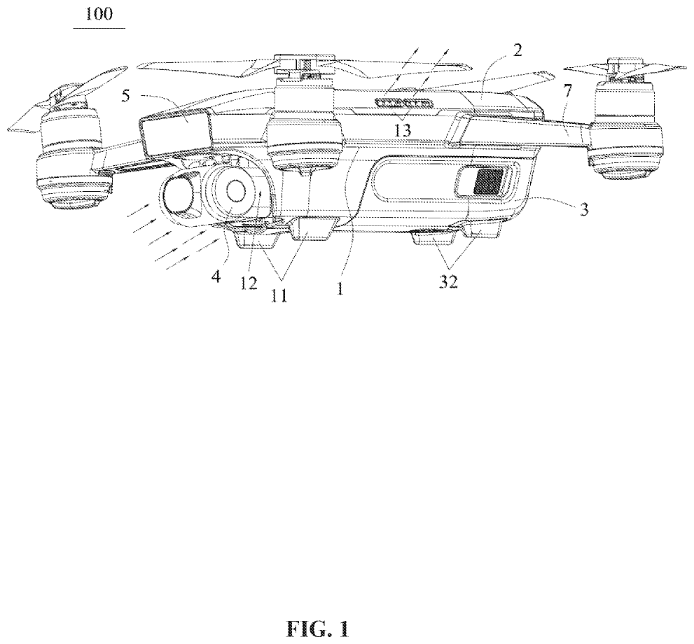

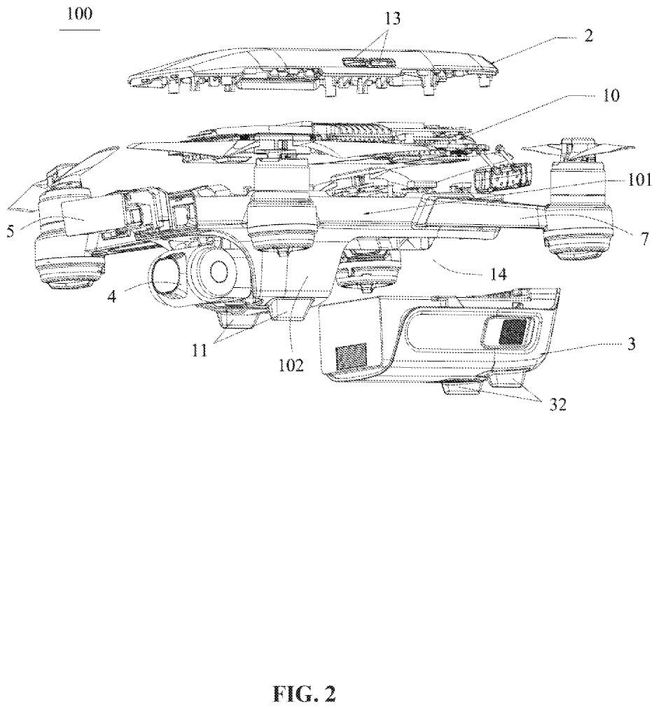

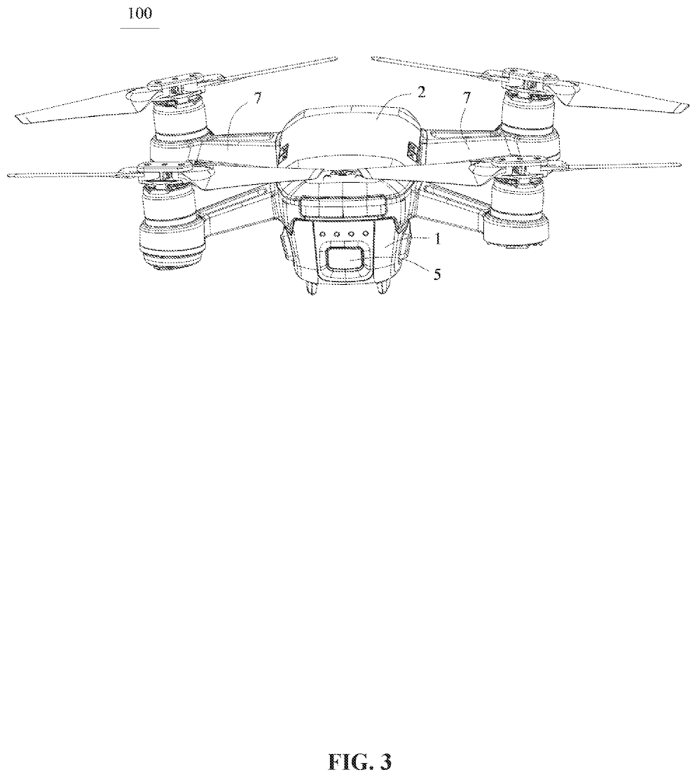

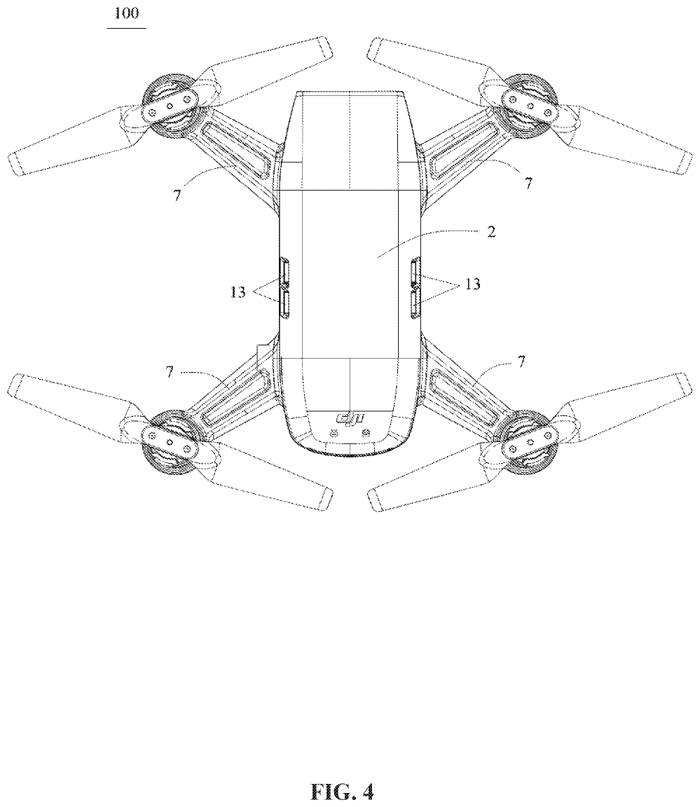

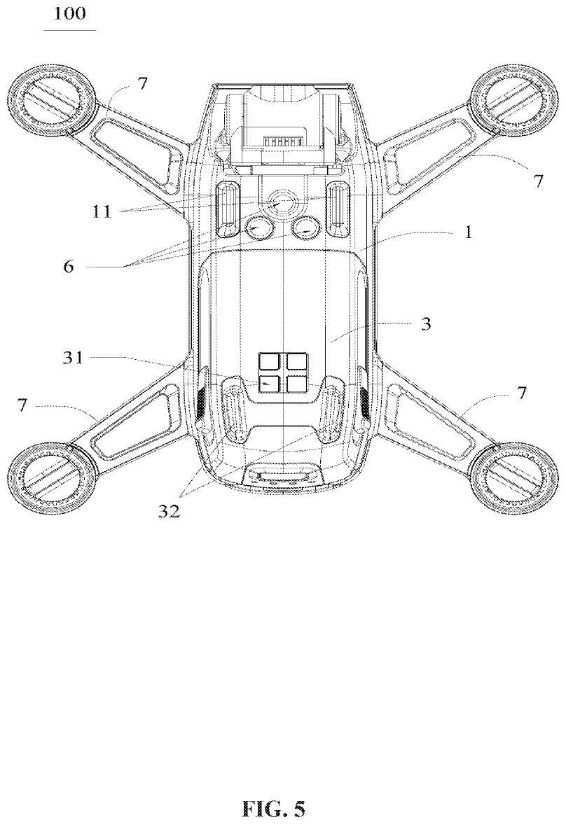

As shown in FIG. 1 to FIG. 5, an unmanned aircraft 100 of the present disclosure may include: an aircraft main body 1, a top cover 2, a battery 3, and a gimbal assembly module 4. The aircraft main body 1 may be provided with a motherboard 10. The top cover 2 may be mounted to the aircraft main body 1. The top cover 2 may seal the motherboard 10 inside the aircraft main body 1. The battery 3 and the gimbal assembly module 4 may be provided (or disposed or located) at a lower portion of the aircraft main body 1. As such, the unmanned aircraft 100 is vertically divided into three layers, which makes the overall configuration of the unmanned aircraft 100 compact. Spaces of the aircraft main body 1 may be fully used. In addition, each structure may be separately assembled, which makes the assembling and maintenance of the unmanned aircraft 100 convenient.

In some embodiments, the motherboard 10 may be electrically connected with various functional modules of the unmanned aircraft 100, and may coordinate the operations of the various functional modules. The motherboard 10 may be disposed inside the aircraft main body 1, and may be located at a middle layer of the unmanned aircraft 100. This configuration reduces the distances between the motherboard 10 and the various functional modules, thereby reducing the wiring inside the aircraft main body 1, and optimizes the configuration of the internal spaces of the unmanned aircraft 100. The top cover 2 may be detachably assembled with the aircraft main body 1 through nesting with one another. The reliability may be further enhanced by fixedly connect the top cover 2 with the aircraft main body 1 through screws.

The battery 3 may be located at a rear lower portion of the aircraft main body 1. The gimbal assembly module 4 may be located at a front lower portion of the aircraft main body 1. In some embodiments, the aircraft main body 1 may include a main body frame 101 and a supporting housing 102 located below the main body frame 101. The supporting housing 102 and the main body frame 101 may couple with one another to form a front lower receiving region and a rear lower receiving region (two receiving regions), configured to accommodate or receive the gimbal assembly module 4 and the battery 3, making the battery 3 and the gimbal assembly module 4 parts of the unmanned aircraft 100. In some embodiments, the supporting housing 102 and the main body frame 101 may be integrally formed, which makes it convenient to detach and assemble the entire machine of the unmanned aircraft 100.

In some embodiments, the unmanned aircraft 100 may include an antenna assembly (not shown). The antenna assembly may be located between the battery 3 and the gimbal assembly module 4. The antenna assembly may include an antenna. The antenna assembly may be configured to communicate with an external device. The external device may include, but not be limited to: a remote controller, a wristband, a watch, virtual reality (“VR”) glasses, a cell phone, or a tablet, etc. In some embodiments, the antenna assembly may be disposed inside the supporting housing 102, such that the unmanned aircraft 100 does not need a tripod for the antenna, which effectively reduces the volume of the unmanned aircraft 100. In addition, the above configuration method can protect the antenna assembly from damages when the unmanned aircraft 100 has an accident (e.g., crash).

The gimbal assembly module 4 may include a gimbal (not shown), a gimbal connector (not shown) configured to connect the gimbal with the aircraft main body 1, and an imaging device (e.g., a camera) fixed to the gimbal. The gimbal may be a two-axis gimbal or a three-axis gimbal. As such, the gimbal may be controlled to rotate around different axes, thereby adjusting the different imaging angles of the unmanned aircraft 100. The front lower receiving space formed by the supporting housing 102 coupling with the main body frame 101 may provide a sufficient space for the imaging device to rotate. The space may function to protect the imaging device, and may avoid the collision between the gimbal assembly module 4 and the aircraft main body 1.

The aircraft main body 1 may include a receiving member 14 configured to mount the battery 3, and a locking mechanism (not shown). The receiving member 14 may be formed by the supporting housing 102 and the main body frame 101. In some embodiments, the battery 3 may be a part of the entire body of the unmanned aircraft 100. A bottom and three side surfaces of the battery 3 connected with the bottom may be parts of the exterior surfaces of the unmanned aircraft 100. As such, the battery 3 may be partially exposed at the exterior surfaces of the unmanned aircraft 100, functioning as part of the aircraft body of the unmanned aircraft 100. This configuration can save on the wall housing of the aircraft body for wrapping the battery 3, thereby reducing the volume and weight of the unmanned aircraft 100, and increasing the space utilization rate of the aircraft body of the unmanned aircraft 100.

The battery 3 may be provided with an electrical connector (not shown) configured to electrically connect with the main body of the unmanned aircraft 100 (e.g., the motherboard 10) to provide power to the unmanned aircraft 100. The aircraft main body 1 may be provided with an electrical coupling part (not shown) configured to couple with the electrical connector. The electrical connector may be disposed on any side surface of the battery 3 that closely contacts the aircraft main body 1. The electrical coupling part may be disposed on the main body frame 101 or the supporting housing 102 corresponding to the electrical connector. In some embodiments, the electrical connector and the electrical coupling part may be coupled through an elastic pin and an elastic plate, or may be through an insertion coupling of the electrical connector, etc.

In some embodiments, an exterior surface of the battery 3 may be provided with a charging contact point 31. The charging contact point 31 may be disposed at a lower portion or a back portion of the unmanned aircraft 100. The charging contact point 31 may be configured to couple with a charger to charge the unmanned aircraft 100. For example, the unmanned aircraft 100 may use a downward view positioning system disposed on the aircraft main body 1 and a positioning device of the charger to realize automatic parking and charging, which does not require manual insertion or pulling of the battery 3 for charging. As a result, the intelligibility of the unmanned aircraft 100 may be enhanced.

In some embodiments, a lower surface of the battery 3 may be provided with a foot pad 32 configured to abut against a supporting surface when the unmanned aircraft 100 lands on the supporting surface. In some embodiments, the lower surface of the battery 3 may be provided with two foot pads 32. The charging contact point 31 may be disposed between the two foot pads 32. The foot pads 32 may protect the charging contact point 31.

In some embodiments, the locking mechanism may couple with the receiving member 14 to lock the battery 3 to the aircraft main body 1. By adjusting the locking mechanism, the battery 3 may be detachably mounted to the aircraft main body 1. This configuration makes it convenient to replace the battery 3 without needing to disassemble other components of the unmanned aircraft 100.

In some embodiments, the locking mechanism may include a first snap-fit member disposed at an end of the receiving member 14 adjacent the gimbal assembly module 14, and a snap-hold member disposed at an end of the receiving member 14 away from the gimbal assembly module 4. The first snap-fit member may be disposed on the supporting housing 102. The snap-hold member may be disposed on the main body frame 101. In some embodiments, the battery 3 may be pre-positioned through coupling with the first snap-fit member, and may be fixed through the snap-hold member.

In some embodiments, the first snap-fit member may be a cover shell or a snap-fit hole disposed on the supporting housing 102. The snap-hold member may be a pressing button mechanism. The pressing button mechanism may include a typical coupling mechanism including a pressing member, an elastic spring, and a snap-fit hook. Correspondingly, the battery 3 may be provided with a snap-buckle member coupling with the pressing button mechanism. In some embodiments, when the first snap-fit member is a snap-fit hole, the battery 3 may be provided with a snap tongue continued to couple with the first snap-fit hole.

In some embodiments, the locking mechanism may include a second snap-fit member disposed at an end of the receiving member 14 adjacent the gimbal assembly module 4, a telescopic arm disposed at a bottom surface of the receiving member 14, and a position-limiting member disposed at a free end of the telescopic arm. The second snap-fit member may be disposed on the supporting housing 102, and the telescopic arm may be disposed on the main body frame 101. In some embodiments, the battery 3 may be pre-positioned through the second snap-fit member, and be clamped tightly through the telescopic arm coupling with the position-limiting member. In some embodiments, the second snap-fit member may be a cover shell or a snap-fit hole disposed on the supporting housing 102. Correspondingly, when the second snap-fit member is a snap-fit hole, the battery 3 may be provided with a snap tongue configured to couple with the second snap-fit hole.

In some embodiments, the aircraft main body 1 may be provided with a snap-fit groove (not shown) such that a protrusion (not shown) of the battery 3 may be coupled with the snap-fit groove, making it convenient for the battery 3 to be mounted into the receiving member 14. In some embodiments, the protrusion may be disposed on the aircraft main body 1, and the snap-fit groove may be disposed on the battery 3.

In some embodiments, the unmanned aircraft 100 may include a front vision module 5 disposed at the front side of the aircraft main body 1. The front vision module 5 may be configured to detect an obstacle ahead of the unmanned aircraft 100. In some embodiments, the front vision module 5 may include a binocular vision sensor, a time of flight (“TOF”) sensor, etc., thereby enhancing the detection accuracy of the front vision module 5.

In some embodiments, the unmanned aircraft 100 may include a height detection module 6 disposed at a lower portion of the aircraft main body 1. The height detection module 6 may be configured to detect a flight height of the unmanned aircraft 100. The height detection module 6 may include at least one of an altitude keeping sensor, a barometer, an ultrasonic sensor, a displacement sensor, or a distance sensor. In some embodiments, the height detection module 6 may be located between the battery 3 and the gimbal assembly module 4, i.e., located on the supporting housing 102.

In some embodiments, the unmanned aircraft 100 may include at least two foot pads 11 located at a lower portion of the aircraft main body 1. The two foot pads 11 may be disposed at two sides of the height detection module 6, respectively. That is, the height detection module 6 and the foot pads 11 may be disposed on the supporting housing 102. The foot pads 11 may function to protect the height detection module 6. In some embodiments, the foot pads 11 disposed on the supporting housing 102 and the foot pads 32 disposed at a lower portion of the battery 3 may couple with one another to form a supporting structure of the unmanned aircraft 100. In some embodiments, a lateral strip shaped foot pad may be disposed at a lower portion of the supporting housing 102 and a lower portion of the battery 3, respectively. The two lateral strip shaped foot pads can also form a protective space at a lower portion of the unmanned aircraft 100, which may protect the aircraft body of the unmanned aircraft 100 and the height detection module 6 and the charging contact point 31 disposed on the aircraft main body 1.

In some embodiments, the unmanned aircraft 100 may include a heat dissipation air channel disposed inside the unmanned aircraft 100. In some embodiments, an air entrance port 12 of the heat dissipation air channel may be disposed at a front end of the aircraft main body 1. An air exit port 13 of the heat dissipation air channel may be disposed at a rear half portion of the aircraft main body 1. The motherboard 10 may be located within the heat dissipation air channel. In some embodiments, the air entrance port 12 of the heat dissipation air channel may be disposed at the location where the gimbal assembly module 4 is mounted to the aircraft main body 1. That is, the heat dissipation air channel may be disposed at a connecting part of the gimbal and the aircraft main body 1. The air exit port 13 of the heat dissipation air channel may be disposed on the top cover 2. In some embodiments, the unmanned aircraft 100 may use a suction type high rotation speed fan cooling system implemented on the aircraft main body 1 (e.g., a high rotation speed fan disposed on the motherboard 10), which may be used in combination with the heat dissipation air channel to dissipate heat at a maximum efficiency. In some embodiments, the heat dissipation air channel may use an air cooling configuration in which air enters at the front and exists from the two sides. That is, the air may enter from the mounting location of the gimbal assembly module 4 of the unmanned aircraft 100, and exit from two waist sides of the unmanned aircraft 100.

In some embodiments, the unmanned aircraft 100 may include at least one aircraft arm 7 disposed at the aircraft main body 1. Each aircraft arm 7 may be connected with a propeller to provide a flight propulsion for the unmanned aircraft 100. In some embodiments, the unmanned aircraft 100 may include multiple aircraft arms 7 and multiple propellers symmetrically disposed at the two sides of the aircraft main body 1, to provide excellent flight propulsion and flight stability for the unmanned aircraft 100. The present disclosure does not limit the structure of the aircraft wing of the unmanned aircraft 100. Any suitable structure of the aircraft wing that can enable the unmanned aircraft 100 to fly may be used in the present disclosure.

In the unmanned aircraft of the present disclosure, the top cover may be disposed at a top portion of the aircraft main body, and the battery and the gimbal assembly module may be disposed at a lower portion of the aircraft main body. As such, the unmanned aircraft may be divided into three layers of structures. The overall configuration of the unmanned aircraft is compact. The appearance is smooth and aesthetically pleasing. The space utilization rate is high. As a result, the weight of the aircraft is reduced, which enhances the flight time of the unmanned aircraft.

It should be understood that in the present disclosure, relational terms such as first and second, etc., are only used to distinguish an entity or operation from another entity or operation, and do not necessarily require or imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

The above describes in detail various embodiments of the method and device of the present disclosure. Specific examples are used to explain the principle and implementation methods of the present disclosure. The explanations of the above embodiments are only for facilitating the understanding of the disclosed method and the core principle. A person having ordinary skills in the art may modify the detailed implementation methods and application scope based on the spirit of the present disclosure. The contents of the present specification should not be understood as limiting the scope of the present disclosure.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. An unmanned aircraft, comprising:
an aircraft main body;
a motherboard disposed inside the aircraft main body;
a top cover mounted on the aircraft main body and configured to seal the motherboard inside the aircraft main body; and
a battery, a gimbal assembly module, and an antenna assembly disposed at a lower portion of the aircraft main body,
wherein the battery is disposed at a rear lower portion of the aircraft main body, the gimbal assembly module is located at a front lower portion of the aircraft main body, and the antenna assembly is between the battery and the gimbal assembly module.

2. The unmanned aircraft of claim 1, further comprising:
a front vision module disposed at a front end of the aircraft main body and configured to detect an obstacle ahead of the unmanned aircraft.

3. The unmanned aircraft of claim 1, further comprising:
a height detection module disposed at the lower portion of the aircraft main body and configured to detect a flight height of the unmanned aircraft.

4. The unmanned aircraft of claim 3,
wherein the height detection module is located between the battery and the gimbal assembly module.

5. The unmanned aircraft of claim 4, further comprising:
at least two foot pads disposed at the lower portion of the aircraft main body, wherein the two foot pads are disposed at two sides of the height detection module.

6. The unmanned aircraft of claim 5,
wherein the aircraft main body comprises a main body frame and a supporting housing disposed at a lower portion of the main body frame,
wherein the supporting housing and the main body frame couple together to form a receiving space for the gimbal assembly module and the battery, and
wherein the height detection module and the at least two foot pads are disposed on the supporting housing, and the antenna assembly is disposed inside the supporting housing.

7. The unmanned aircraft of claim 3, wherein the height detection module comprises at least one of an altitude keeping sensor, a barometer, an ultrasonic sensor, a displacement sensor, or a distance sensor.

8. The unmanned aircraft of claim 1, further comprising:
a heat dissipation air channel including an air entrance port disposed at a front end of the aircraft main body, and an air exit port disposed at a rear half portion of the aircraft main body, wherein the motherboard is disposed inside the heat dissipation air channel.

9. The unmanned aircraft of claim 8, wherein the air entrance port of the heat dissipation air channel is disposed at a location where the gimbal assembly module is mounted to the aircraft main body, and the air exit port is disposed on the top cover.

10. The unmanned aircraft of claim 1, wherein the aircraft main body comprises a receiving member configured to mount the battery, and a locking mechanism, and wherein the locking mechanism is configured to couple with the receiving member to lock the battery to the aircraft main body.

11. The unmanned aircraft of claim 10, wherein the locking mechanism comprises a first snap-fit member disposed at an end of the receiving member adjacent the gimbal assembly module, and a snap-hold member disposed at an end of the receiving member away from the gimbal assembly module.

12. The unmanned aircraft of claim 10, wherein the locking mechanism comprises a second snap-fit member disposed at the end of the receiving member adjacent the gimbal assembly module, and a telescopic arm disposed at a bottom surface of the receiving member, and a position-limiting member disposed at a free end of the telescopic arm.

13. The unmanned aircraft of claim 1, wherein an exterior surface of the battery includes a charging contact point configured to couple with a charger to charge the unmanned aircraft.

14. The unmanned aircraft of claim 1, wherein the gimbal assembly module comprises a gimbal, a gimbal connector configured to connect the gimbal with the aircraft main body, and an imaging device fixed to the gimbal.
